(19) United States
(12) Patent Application Publication
(10) Pub. No.: US 2018/0123621 A1
(43) Pub. Date: May 3, 2018

(54) MULTI-MODE MULTI-BAND TRANSCEIVER, RADIO FREQUENCY FRONT-END CIRCUIT AND RADIO FREQUENCY SYSTEM USING THE SAME

(71) Applicant: Airoha Technology Corp., Hsinchu (TW)

(72) Inventors: Heng-Chih Lin, Hsinchu City (TW); Chien-Kuang Lee, Jhubei City (TW)

(21) Appl. No.: 15/782,898

(22) Filed: Oct. 13, 2017

(30) Foreign Application Priority Data
Oct. 28, 2016 (TW) 105135073

(51) Int. Cl. H04B 1/00; H04B 7/06

(52) U.S. Cl. CPC H04B 1/0064; H04W 88/06; H04B 7/0602

(57) ABSTRACT

A radio frequency (RF) system including a transceiver and an RF front-end circuit is provided. The transceiver has a signal transmitting port, which selectively transmits a first RF signal or a second RF signal, wherein the first RF signal corresponds to a first communication mode and a first band, and the second RF signal corresponds to a second communication mode and a second band. The RF front-end circuit is coupled to the transceiver, and includes a transmission path switch and an antenna switch. The transmission path switch electrically couples the signal transmitting port to a selected signal transmission path of a plurality of signal transmission paths. The antenna switch is coupled to the signal transmission paths, and electrically couples the selected signal transmission path to the antenna module.

This application claims the benefit of Taiwan application Serial No. 105135073, filed Oct. 28, 2016, the subject matter of which is incorporated herein by reference.

### BACKGROUND OF THE INVENTION

### Field of the Invention

The invention relates in general to a transceiver, an RF front-end circuit and an RF system using the same, and more particularly to a multi-mode multi-band (MMMB) transceiver, an RF front-end circuit and an RF system using the same.

### Description of the Related Art

In recent years, the development of communication electronic products (such as smart phones) is directed towards the support of multi-mode multi-band transmission and the compatibility with different wireless communication technologies. The multi-mode multi-band (MMMB) technology allows the device to be switched between different communication modes such as 2G/3G/4G communication modes, and supports the transmission of signals corresponding to different operating bands under each communication mode.

For the RF front-end elements (such as the transceiver) to support multi-mode multi-band operations, the quantity of signal ports (such as chip pins) needs to be increased. For example, the transceiver may need to provide a plurality of signal ports corresponding to different operating bands (such as 824 MHz to 915 MHz, 1710 MHz to 1910 MHz) under the 2G communication mode, and provide a plurality of transmitting ports corresponding to different operating bands (such as 2300 MHz to 2700 MHz, 1700 MHz to 2000 MHz, 700 MHz to 900 MHz) under the 3G/4G communication mode. However, a large quantity of signal ports will make circuit layout become very complicated, and the circuit area and circuit costs will be increased accordingly, which is unfavorable to circuit design and integration.

Therefore, it has become a prominent task for the industry to provide a technology capable of reducing the quantity of signal ports of multi-mode multi-band RF elements.

### SUMMARY OF THE INVENTION

The invention is directed to a multi-mode multi-band transceiver, an RF front-end circuit and an RF system using the same. RF signals corresponding to different communication modes and/or bands are transmitted through single path, such that the quantity of signal ports of the elements can be reduced.

According to one embodiment of the present invention, a radio frequency (RF) system including a transceiver and an RF front-end circuit is provided. The transceiver has a signal transmitting port, which selectively transmits a first RF signal or a second RF signal, wherein the first RF signal corresponds to a first communication mode and a first band, and the second RF signal corresponds to a second communication mode and a second band. The RF front-end circuit is coupled to the transceiver, and includes a transmission path switch and an antenna switch. The transmission path switch electrically couples the signal transmitting port to a selected signal transmission path of a plurality of signal transmission paths. The antenna switch is coupled to the signal transmission paths, and electrically couples the selected signal transmission path to the antenna module.

According to another embodiment of the invention, a transceiver including a controller and the drive amplifier is provided. The controller provides a band switching signal. The drive amplifier is controlled by the controller and coupled to a signal transmitting port of the transceiver. The drive amplifier includes a frequency dependent load set, a band selector and an amplifier circuit. The frequency dependent load set includes a plurality of frequency dependent loads. The band selector is switched between the frequency dependent loads in response to the band switching signal. The amplifier circuit is coupled to the band selector, and electrically coupled to one of the frequency dependent loads through the band selector. When the amplifier circuit is coupled to a first frequency dependent load of the frequency dependent loads, the amplifier circuit outputs a first RF signal to the signal transmitting port. When the amplifier circuit is coupled to a second frequency dependent load of the frequency dependent loads, the amplifier circuit outputs a second RF signal to the signal transmitting port. The first RF signal corresponds to a first communication mode and a first band. The second RF signal corresponds to a second communication mode and a second band.

According to an alternate embodiment of the invention, an RF front-end circuit including a transmission path switch and the antenna switch is provided. The transmission path switch selectively and electrically couples a signal transmitting port of the transceiver to one of a plurality of signal transmission paths. The antenna switch is coupled to the signal transmission paths for transmitting the signals coming from the signal transmission paths to the antenna module; wherein when the signal transmitting port transmits the first RF signal, the transmission path switch electrically couples the signal transmitting port to a first signal transmission path of the signal transmission paths to transmit the first RF signal to the antenna module, when the signal transmitting port transmits the second RF signal, the transmission path switch electrically couples the signal transmitting port to a second signal transmission path of the signal transmission paths to transmit the second RF signal to the antenna module. The first RF signal corresponds to a first communication mode and a first band. The second RF signal corresponds to a second communication mode and a second band.

The above and other aspects of the invention will become better understood with regard to the following detailed description of the preferred but non-limiting embodiment (s). The following description is made with reference to the accompanying drawings.

### BRIEF DESCRIPTION OF THE DRAWINGS

FIG. 1 is a block diagram of an RF system according to an embodiment of the invention.

FIG. 1A is a block diagram of an RF system according to an embodiment of the invention.

FIG. 2 is a partial block diagram of a transceiver according to an embodiment of the invention.

FIGS. 3A to 3C are combination diagrams of a frequency dependent load set and a band selector according to different embodiments of the invention.

### DETAILED DESCRIPTION OF THE INVENTION

A number of embodiments of the present invention are disclosed below with reference to accompanying drawings, but not every embodiment is illustrated in accompanying drawings. In practical application, the present invention can have different variations and is not limited to the embodiments exemplified in the specification. A number of embodiments are disclosed in the present disclosure to meet the statutory requirements. Designations common to the accompanying drawings are used to indicate identical or similar elements.

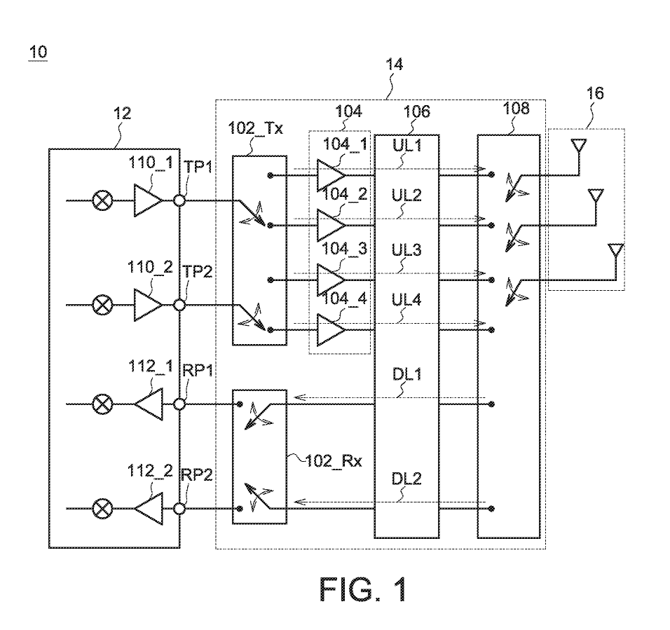

FIG. 1 is a block diagram of an RF system 10 according to an embodiment of the invention. The RF system 10 supports multi-mode multi-band signal transmission to adapt to the carrier aggregation (CA) technology. The RF system 10 mainly includes a transceiver 12 and an RF front-end circuit 14.

The transceiver 12 transmits and receives RF signals. For example, the transceiver 12 can transmit the RF signals to the RF front-end circuit 14. The RF signals are amplified and filtered, and then are wirelessly transmitted through the antenna module 16. After the signals received from the antenna module 16 are processed by the RF front-end circuit 14 (such as filtered by the RF front-end circuit 14), the signals are transmitted to the transceiver 12, which converts the signals to a form that can be processed by a baseband processing chip.

The transceiver 12 has one or more signal ports (such as chip pins) for communicating signals with external elements. The signal ports, through which RF signals are transmitted, are referred as “signal transmitting ports”; the signal ports, through which RF signals received, are referred as “signal receiving ports”. As indicated in FIG. 1, the transceiver 12 has signal transmitting ports TP1 and TP2 and signal receiving ports RP1 and RP2, wherein the signal transmitting ports TP1 and TP2 are coupled to the drive amplifier 110_1 and 110_2, respectively; the signal receiving ports RP1 and RP2 are coupled to the low-noise amplifiers 112_1 and 112_2, respectively.

According to the embodiments of the invention, the transceiver 12 can transmit RF signals corresponding to different communication modes and/or bands through single signal port, such that the required quantity of signal ports by which the transceiver 12 supports multi-mode multi-band signal transmission can be reduced.

For example, the signal transmitting port TP1 selectively transmits a first RF signal or a second RF signal, wherein the first RF signal corresponds to a first communication mode and a first band, and the second RF signal corresponds to a second communication mode and a second band.

The signal port of the invention can selectively transmit different band signals under the same communication mode. For example, the signal transmitting port TP1 can selectively transmit the first RF signal or the second RF signal, wherein the first RF signal corresponds to the first band under the first communication mode, the second RF signal corresponds to the second band under the first communication mode.

The said communication mode refers to the wireless communication technology adopted by the communication system, such as the global system for mobile communications (GSM) technology for 2G mobile communication, the wideband code division multiple access (WCDMA) technology for 3G mobile communication, and the long term evolution (LTE) technology for 4G mobile communication. The said band refers to a specific frequency range, and the definition of band division is dependent on the communication mode. In the LTE technology, 43 bands (band 1 to band 43) are defined.

An application is disclosed for illustrative purpose. The first RF signal is a 2G mobile communication signal having a band range of 824 MHz to 915 MHz. The second RF signal is a 4G mobile communication signal having a band range of band 40 defined by the LTE technology. Both the first RF signal and the second RF signal can be transmitted through the same signal port (such as signal transmitting port TP1).

In an embodiment, the drive amplifier 110_1/110_2 can switch and change its load to selectively output the first/second RF signal to the signal transmitting port TP1/TP2.

It can be understood that the invention is not limited thereto. In some embodiments, single signal port of the transceiver 12 can support the transmission of signals corresponding to different mode or bands. For example, the transceiver 12 can transmit 2G, 3G and 4G mobile communication signals through single signal port.

The RF front-end circuit 14 is coupled to the transceiver 12, and mainly includes a transmission path switch 102_Tx and an antenna switch 108.

A plurality of signal transmission paths UL1 to UL4 defined by the power amplifier set 104 and the filter set 106 are formed between the transmission path switch 102_Tx and the antenna switch 108. The power amplifier set 104 includes a plurality of power amplifiers 104_1 to 104_4 corresponding to different bands. The filter set 106 includes a plurality of filters (such as filters and duplexers) corresponding to different bands.

In an embodiment, each of the signal transmission paths UL1 to UL4 includes one or more power amplifiers and filters.

In the example of FIG. 1, the signal transmission path UL1 is defined as a path from the power amplifier 104_1 to the antenna switch 108 through a specific filter of the filter set 106. The signal transmission path UL2 is defined as a path from the power amplifier 104_2 to the antenna switch 108 through a specific filter of the filter set 106.

The transmission path switch 102_Tx can electrically couple the signal transmitting port TP1/TP2 to a selected signal transmission path of the signal transmission paths UL1 to UL4. The RF signal transmitted by the transceiver 12 reaches the antenna switch 108 through the selected signal transmission path. In general, the selection of the signal transmission path is dependent on the band range of the to-be-transmitted RF signal. That is, in the selected signal transmission path, the bands of the power amplifier and the filter need to support the band of the RF signal such that the power amplifier and the filter can suitably amplify or filter the RF signal.

The antenna switch 108 is coupled to a plurality of signal transmission paths UL1 to UL4, and can electrically couple a selected signal transmission path of the to-be-transmitted RF signal to the antenna module 16, such that the RF signal can be wirelessly transmitted by the antenna module 16. For example, the antenna switch 108 can be switched between multiple antennas of the antenna module 16 to transmit the RF signal by using a suitable antenna.

In the example of FIG. 1, the RF front-end circuit 14 further includes a reception path switch 102_Rx coupled to the signal receiving ports RP1 and RP2 of the transceiver 12 for switching the signal receiving ports RP1 and RP2 between the signal reception paths DL1 and DL2. The signal reception paths DL1 and DL2 are defined between the reception path switch 102_Rx and the antenna switch 108. In an embodiment, each of the signal reception paths DL1 and DL2 includes one or more filters.

The reception path switch 102_Rx can transmit the RF signal corresponding to different communication modes and/or bands to single signal port (such as signal receiving port RP1/RP2) of the transceiver 12.

Suppose the signal reception paths DL1 and DL2 are used for transmitting a third RF signal and a fourth RF signal, respectively. The third RF signal corresponds to a third communication mode and a third band (such as a 2G mobile communication signal operated within a specific band). The fourth RF signal corresponds to a fourth communication mode and a fourth band (such as a 3G/4G mobile communication signal operated within another specific band). The reception path switch 102_Rx can switch the signal reception paths DL1 and DL2 to be electrically coupled to the signal receiving port RP1, such that the RF signals corresponding to different communication modes or bands can be received through single signal receiving port RP1.

The signal receiving port of the invention can selectively receive signal having different bands under the same communication mode. For example, the signal receiving port RP1 can selectively receive a third RF signal or a fourth RF signal, wherein the third RF signal corresponds to the third band under the third communication mode, and the fourth RF signal corresponds to the fourth band under the third communication mode.

In an embodiment, the low-noise amplifier 112_1/112_2 coupled to signal receiving port RP1/RP2 can switch and change its load, such that the third RF signal or the fourth RF signal can be correspondingly amplified.

It can be understood that the invention is not limited thereto. In some embodiments, single signal receiving port of the transceiver 12 can support the transmission of signals corresponding to more than two different modes or bands. For example, the 2G, 3G and 4G mobile communication signals can be received through single signal receiving port.

It can be understood that in FIG. 1, the quantity of each element (such as drive amplifier, low-noise amplifier, and power amplifier), the quantity of each signal port (such as signal transmitting port and signal receiving port) and the quantity of each signal path (such as signal transmission path and signal reception path) are not limited. Any design is within the spirit of the invention as long as the RF signals corresponding to different communication modes and/or bands are transmitted through single signal port.

FIG. 1A is a block diagram of an RF system 10′ according to an embodiment of the invention. In the example of FIG. 1A, the filter set 106′ includes filters 1602, 1606 and 1608, a duplexer 1604 and a switch 1610. Some signal transmission paths and some signal reception paths are combined as one path in the filter set 106, and the combined path is further connected to the antenna switch 108. For example, the signal transmission path UL2′ and the signal reception path DL2′ are combined as one single path by the duplexer 1604, and the combined path is further coupled to the antenna switch 108. The signal transmission path UL3′ and the signal reception path DL3′ are combined as one single path by elements such as the filter 1606 and the switch 1610, and the combined path is further coupled to the antenna switch 108.

Some other signal transmission paths and some other signal reception paths are coupled between the antenna switch 108 and the transmission path switch 102_Tx/the reception path switch 102_Rx through independent paths such as signal transmission paths UL1′ and UL4′.

It can be known from the example of FIG. 1A that the signal transmission path of the invention refers to a specific signal path between a specific port of the transmission path switch 102_Tx and the antenna switch 108; the signal reception path refers to a specific signal path between a specific port of the reception path switch 102_Rx and the antenna switch 108; each signal path may partly overlap with or independent of other paths in the filter set 106. Whether signal path partly overlaps with or is independent of other paths is determined according to the needs of the application.

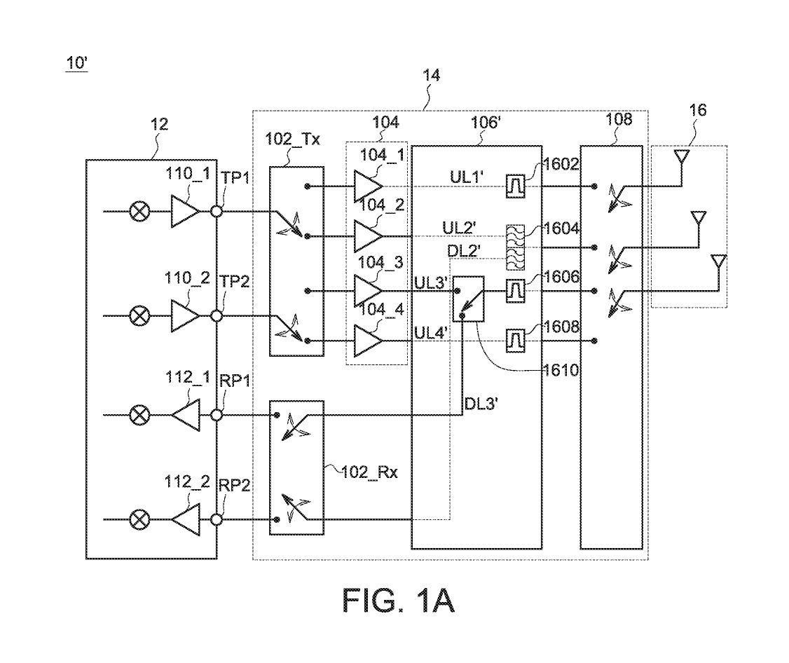

FIG. 2 is a block diagram of a drive amplifier 110_i according to an embodiment of the invention. As an illustrative rather than restrictive sense, the drive amplifier 110_i can be any drive amplifier of the transceiver 12 of FIG. 1.

The output end of the drive amplifier 110_i is coupled to the signal transmitting port TPi of the transceiver.

The drive amplifier 110_i mainly includes a frequency dependent load set 202, a band selector 204 and an amplifier circuit 206.

The frequency dependent load set 202 may include N frequency dependent loads 202_1 to 202_N, which can be implemented by elements whose impedance values vary with the frequency wherein the elements can be realized by inductors or capacitors, and N is a positive integer.

The band selector 204 can be realized by a switch, which can be switched between the frequency dependent loads 202_1 to 202_N.

In an embodiment, the transceiver (such as transceiver 12) further includes a controller 208. The controller 208 provides a band selection signal SEL, and the band selector 204 is electrically coupled to one of the frequency dependent loads 202_1 to 202_N in response to the band selection signal SEL.

The amplifier circuit 206 can be realized by one or more transistors. The amplifier circuit 206 is coupled to the band selector 204 to be electrically coupled to one of the frequency dependent loads 202_1 to 202_N through the band selector 204.

By switching the frequency dependent load coupled to the amplifier circuit 206, the operating band of the amplifier circuit 206 can be adjusted to assure that the amplifier circuit 206 can convert an input signal whose operating band is required under the communication mode into a to-be-outputted RF signal. The said input signal is a modulated carrier signal, and the corresponding communication mode of the input signal is determined by the baseband processing chip.

Through the above operation, single drive amplifier 110_i can switch to output the RF signal corresponding to different communication modes and/or bands to the signal transmitting port TPi, such that the signal paths corresponding to different modes or bands can be integrated into single signal path.

For example, when the amplifier circuit 206 is coupled to a first frequency dependent load (such as 202_1) of the frequency dependent loads 202_1 to 202_N, the amplifier circuit 206 outputs a first RF signal corresponding to a first communication mode and a first band to the signal transmitting port TPi; when the amplifier circuit 206 is coupled to a second frequency dependent load (such as 202_2) of the frequency dependent loads 202_1 to 202_N, the amplifier circuit 206 outputs a second RF signal corresponding to a second communication mode and a second band to the signal transmitting port TPi.

According to the embodiments of the invention, the disposition of the low-noise amplifier of the transceiver is similar to that of the drive amplifier 110_i, and the operating band of the low-noise amplifier can be switched and adjusted, but the direction of signal transmission of the low-noise amplifier is inverse to that of the amplifier circuit. That is, the input end of the amplifier circuit is coupled to the signal receiving port of the transceiver.

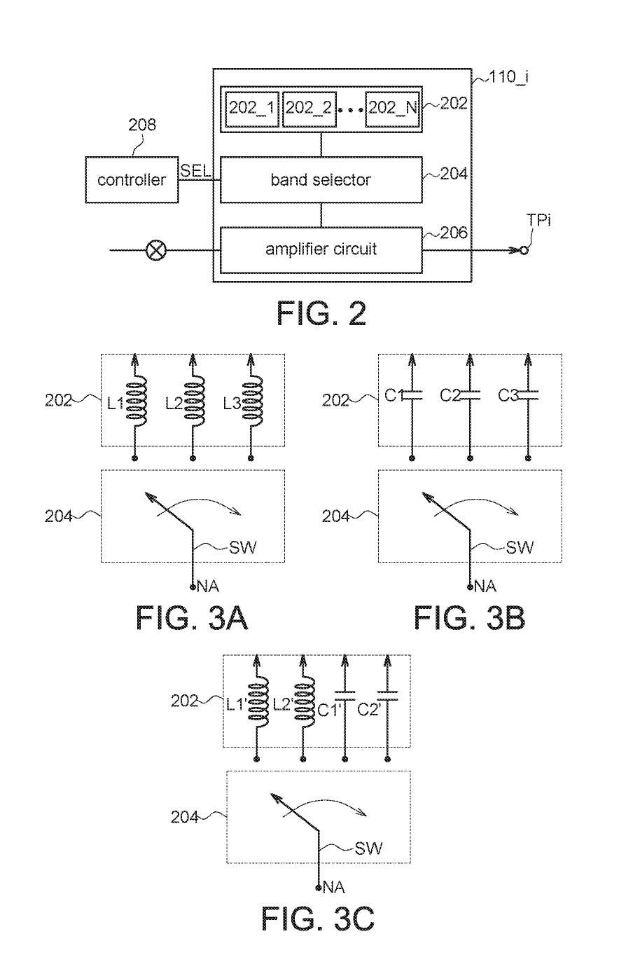

FIGS. 3A to 3C are combination diagrams of a frequency dependent load set and a band selector according to different embodiments of the invention. For convenience of description, designations common to FIGS. 3A to 3C and FIG. 2 are used to indicate identical or similar elements.

In the example of FIG. 3A, the frequency dependent load set 202 includes a plurality of the inductors L1 to L3 having different inductance values. The band selector 204 includes a switch SW. The switch SW, in response to the control of the controller (such as the controller 208), can selectively and electrically couple the node NA to one of the inductor L1 to L3.

The node NA is coupled to the transistor end of the amplifier circuit (such as amplifier circuit 206), such that the load of the amplifier circuit can be switched and adjusted, and the operating band of the amplifier circuit can be changed accordingly.

In the example of FIG. 3B, the frequency dependent load set 202 includes a plurality of the capacitors C1 to C3 having different capacitance values. The band selector 204 includes a switch SW. The switch SW, in response to the control of the controller (such as the controller 208), can selectively and electrically couple the node NA to one of the capacitor C1 to C3.

In the example of FIG. 30, the frequency dependent load set 202 includes at least inductors L1′ and L2′ and at least capacitors C1′ and C2′. The band selector 204 includes a switch SW. The switch SW, in response to the control of the controller (such as the controller 208), can selectively and electrically couple the node NA to at least one of the inductors L1′ and L2′ and the capacitors C1′ and C2′.

It can be understood that the invention is not limited to above exemplifications. In the frequency dependent load set, the quantity and disposition of the capacitor and/or the inductor can be adjusted according to the needs of application.

To summarize, the invention provides a multi-mode multi-band transceiver, an RF front-end circuit and an RF system using the same capable of transmitting the RF signal corresponding to different communication modes and/or bands through single path, such that the quantity of signal ports of the elements can be reduced.

While the invention has been described by way of example and in terms of the preferred embodiment (s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A radio frequency (RF) system, comprising:
a transceiver having a signal transmitting port, which selectively transmits a first RF signal corresponding to a first band or a second RF signal corresponding to a second band; and
an RF front-end circuit coupled to the transceiver, wherein the RF front-end circuit comprises:
a transmission path switch used for electrically coupling the signal transmitting port to a selected signal transmission path of a plurality of signal transmission paths; and
an antenna switch coupled to the signal transmission paths for electrically coupling the selected signal transmission path to an antenna module.

2. The RF system according to claim 1, wherein the first RF signal is corresponds to a first communication mode and the first band, and the second RF signal corresponds to a first communication mode and the second band.

3. The RF system according to claim 1, wherein the first RF signal corresponds to a first communication mode and the first band, and the second RF signal corresponds to a second communication mode and the second band.

4. The RF system according to claim 1, wherein the transceiver comprises:
a controller used for providing a frequency selection signal; and
a drive amplifier controlled by the controller and coupled to the signal transmitting port, wherein the drive amplifier comprises:
a frequency dependent load set comprising a plurality of frequency dependent loads;
a band selector switched between the frequency dependent loads in response to the frequency selection signal; and
an amplifier circuit coupled to the band selector and electrically coupled to one of the frequency dependent loads through the band selector, wherein when the amplifier circuit is coupled to a first frequency dependent load of the frequency dependent loads, the amplifier circuit outputs the first RF signal to the signal transmitting port; when the amplifier circuit is coupled to a second frequency dependent load of the frequency dependent loads, the amplifier circuit outputs the second RF signal to the signal transmitting port.

5. The RF system according to claim 4, wherein the frequency dependent load set comprises a plurality of inductors having different inductance values.

6. The RF system according to claim 4, wherein the frequency dependent load set comprises a plurality of capacitors having different capacitance values.

7. The RF system according to claim 4, wherein the frequency dependent load set comprises at least an inductor or at least a capacitor.

8. The RF system according to claim 1, wherein the transceiver further has a signal receiving port, and the RF front-end circuit further comprises:
a reception path switch coupled to the signal receiving port for switching the signal receiving port between a plurality of signal reception paths defined between the reception path switch and the antenna switch;
wherein one of the signal reception paths is used for transmitting a third RF signal, and another one of the signal reception paths is used for transmitting a fourth RF signal.

9. The RF system according to claim 8, wherein the third RF signal corresponds to a third band under a third communication mode, and the fourth RF signal corresponds to a fourth band under the third communication mode.

10. The RF system according to claim 8, wherein the third RF signal corresponds to a third communication mode and a third band, and the fourth RF signal corresponds to a fourth communication mode and a fourth band.

11. The RF system according to claim 8, wherein the transceiver comprises:
a low-noise amplifier used for amplifying the signals coming from the signal receiving port.

12. The RF system according to claim 8, wherein each signal reception path comprises at least a filter.

13. The RF system according to claim 1, wherein each signal transmission path comprises at least a power amplifier and at least a filter.

14. A transceiver, comprising:
a controller used for providing a frequency selection signal; and
a drive amplifier controlled by the controller and coupled to a signal transmitting port of the transceiver, wherein the drive amplifier comprises:
a frequency dependent load set comprising a plurality of frequency dependent loads;
a band selector switched between the frequency dependent loads in response to the frequency selection signal; and
an amplifier circuit coupled to the band selector and electrically coupled to one of the frequency dependent loads through the band selector, wherein when the amplifier circuit is coupled to a first frequency dependent load of the frequency dependent loads, the amplifier circuit outputs a first RF signal to the signal transmitting port; when the amplifier circuit is coupled to a second frequency dependent load of the frequency dependent loads, the amplifier circuit outputs a second RF signal to the signal transmitting port.

15. The transceiver according to claim 14, wherein the frequency dependent load set comprises a plurality of inductors having different inductance values.

16. The transceiver according to claim 14, wherein the frequency dependent load set comprises a plurality of capacitors having different capacitance values.

17. The transceiver according to claim 14, wherein the frequency dependent load set comprises at least an inductor or at least a capacitor.

18. The transceiver according to claim 14, further comprising:
a low-noise amplifier used for amplifying the signals corning from a signal receiving port of the transceiver;
wherein the signal receiving port is switched to be electrically coupled to a plurality of signal reception paths, one of the signal reception paths is used for transmitting a third RF signal, and another one of the signal reception paths is used for transmitting a fourth RF signal.

19. An RF front-end circuit, comprising:
a transmission path switch used for selectively and electrically coupling a signal transmitting port of a transceiver to one of a plurality of signal transmission paths; and
an antenna switch coupled to the signal transmission paths for transmitting the signals coming from the signal transmission paths to an antenna module;
wherein when the signal transmitting port transmits a first RF signal, the transmission path switch electrically couples the signal transmitting port to a first signal transmission path of the signal transmission paths to transmit the first RF signal to the antenna module;
when the signal transmitting port transmits a second RF signal, the transmission path switch electrically couples the signal transmitting port to a second signal transmission path of the signal transmission paths for transmitting the second RF signal to the antenna module.

20. The RF front-end circuit according to claim 19, wherein the first RF signal corresponds to a first band under a first communication mode, and the second RF signal corresponds to a second band under a first communication mode.

21. The RF front-end circuit according to claim 19, wherein the first RF signal corresponds to a first communication mode and a first band, and the second RF signal corresponds to a second communication mode and a second band.

22. The RF front-end circuit according to claim 19, further comprising:
a reception path switch coupled to a signal receiving port of a transceiver for switching the signal receiving port between a plurality of signal reception paths defined between the reception path switch and the antenna switch;
wherein one of the signal reception paths is used for transmitting a third RF signal, and another one of the signal reception paths is used for transmitting a fourth RF signal.

23. The RF front-end circuit according to claim 22, wherein the third RF signal corresponds to a third band under a third communication mode, and the fourth RF signal corresponds to a fourth band under a third communication mode.

24. The RF front-end circuit according to claim 22, the third RF signal corresponds to a third communication mode and a third band, and the fourth RF signal corresponds to a fourth communication mode and a fourth band.

25. The RF front-end circuit according to claim 22, wherein each signal reception path comprises at least a filter.

26. The RF front-end circuit according to claim 19, wherein each signal transmission path comprises at least a power amplifier and at least a filter.
